(19) United States
(12) Patent Application Publication
(10) Pub. No.: US 2024/0257149 A1
(43) Pub. Date: Aug. 1, 2024

(54) METHOD AND SYSTEM FOR GENERATION OF INSIGHTS FROM REGULATORY FILINGS

(71) Applicant: JPMorgan Chase Bank, N.A., New York, NY (US)

(72) Inventors: William WATSON, Long Beach, NY (US); Naan CHO, Long Island City, NY (US); Andrea STEFANUCCI, Hoboken, NJ (US); Sameena SHAH, Scarsdale, NY (US); Manuela VELOSO, New York, NY (US)

(73) Assignee: JPMorgan Chase Bank, N.A., New York, NY (US)

(21) Appl. No.: 18/103,807

(22) Filed: Jan. 31, 2023

(51) Int. Cl. G06Q 30/018

(52) U.S. Cl. CPC G06Q 30/018

(57) ABSTRACT

A method and a system for methods and systems for using artificial intelligence techniques to generate insights from public data for potential commercial exploitation in a speedy, large-scale, and sophisticated manner are provided. The method includes: receiving a first document that includes first information that has been submitted for compliance with at least one governmental regulation and is publicly available; extracting the first information from the first document; analyzing the extracted first information by applying an artificial intelligence (AI) algorithm that implements a machine learning technique; and generating at least one insight based on a result of the analysis.

### BACKGROUND

### 1. Field of the Disclosure

This technology generally relates to methods and systems for using artificial intelligence techniques to generate insights from public data for potential commercial exploitation in a speedy, large-scale, and sophisticated manner.

### 2. Background Information

Many commercial entities use a variety of methods for identifying leads for potential sales and revenue generation. In many instances, such leads are identified by using publicly available information. However, the volume of such information is large, and the task of processing such information in order to identify insights that may be commercially valuable tends to be time consuming and labor intensive.

In this aspect, there is a gap between information discovery, extraction, and insight generation. Conventionally, client-prospect data collection has relied heavily on third party vendors and/or internal analysts. With this manual effort, capturing the entire universe of asset managers and funds is infeasible, as it is subject to scalability, operational bottlenecks, and/or vendor limitations. Furthermore, human analysts can be subject to fatigue, and may inject errors in the data procurement process. Training analysts to properly discover and read governmental and regulatory filings is also a blocker in data sourcing. Finally, client intelligence is heavily concentrated and reliant on internal stakeholders with incumbent knowledge.

Accordingly, there is a need for a method for using artificial intelligence techniques to generate insights from public data for potential commercial exploitation in a speedy, large-scale, and sophisticated manner.

### SUMMARY

The present disclosure, through one or more of its various aspects, embodiments, and/or specific features or sub-components, provides, inter alia, various systems, servers, devices, methods, media, programs, and platforms for using artificial intelligence techniques to generate insights from public data for potential commercial exploitation in a speedy, large-scale, and sophisticated manner.

According to an aspect of the present disclosure, a method for generating an insight from public data for potential commercial exploitation is provided. The method is implemented by at least one processor. The method includes: receiving, by the at least one processor, a first document that includes first information that has been submitted for compliance with at least one governmental regulation and is publicly available; extracting, by the at least one processor from the first document, the first information; analyzing, by the at least one processor, the extracted first information by applying a first artificial intelligence (AI) algorithm that implements a machine learning technique; and generating, by the at least one processor, at least one insight based on a result of the analyzing.

The analyzing may include identifying, from among the extracted first information, second information that relates to assets and third information that relates to liabilities.

The analyzing may further include identifying at least one tabular structure from within the first document and reformatting information from within the at least one tabular structure.

The analyzing may further include disambiguating information from within the first information that relates to net assets from information from within the first information that relates to net assets per investment class.

The analyzing may further include identifying, from among the extracted first information, fourth information that relates to at least one currency value.

The analyzing may further include correlating the at least one currency value with a table header in order to identify a candidate fund name.

The generating may include generating, for a first asset manager that is associated with a plurality of subsidiaries, a graphical depiction of respective sets of managed assets with respect to corresponding subsidiaries from among the plurality of subsidiaries.

The generating may further include generating, for a second asset manager that is associated with a fund for which at least one from among a merger and an acquisition has been completed, a message that indicates an effect that has occurred as a result of the at least one from among the merger and the acquisition.

The generating may further include generating an alert message that includes a notification of a changed financial condition that has occurred within a predetermined time interval.

The first document may include at least one from among a Form ADV, a Form N-CSR, a Form NPORT-P, a Form 13F-HR, a Form N-CEN, a Form N-MFP, and a Form D.

The first information may include at least one from among an amount of assets under management (AUM) with respect to a first asset manager, an amount of assets under custody (AUC) with respect to the first asset manager, and an amount of assets under administration (AUA) with respect to the first asset manager.

According to another exemplary embodiment, a computing apparatus for generating an insight from public data for potential commercial exploitation is provided. The computing apparatus includes a processor; a memory; a display; and a communication interface coupled to each of the processor, the memory, and the display. The processor is configured to: receive, via the communication interface, a first document that includes first information that has been submitted for compliance with at least one governmental regulation and is publicly available; extract, from the first document, the first information; analyze the extracted first information by applying a first artificial intelligence (AI) algorithm that implements a machine learning technique; and generate at least one insight based on a result of the analysis.

The processor may be further configured to identify, from among the extracted first information, second information that relates to assets and third information that relates to liabilities.

The processor may be further configured to identify at least one tabular structure from within the first document and to reformat information from within the at least one tabular structure.

The processor may be further configured to disambiguate information from within the first information that relates to net assets from information from within the first information that relates to net assets per investment class.

The processor may be further configured to identify, from among the extracted first information, fourth information that relates to at least one currency value.

The processor may be further configured to correlate the at least one currency value with a table header in order to identify a candidate fund name.

The processor may be further configured to generate, for a first asset manager that is associated with a plurality of subsidiaries, a graphical depiction of respective sets of managed assets with respect to corresponding subsidiaries from among the plurality of subsidiaries.

The processor may be further configured to generate, for a second asset manager that is associated with a fund for which at least one from among a merger and an acquisition has been completed, a message that indicates an effect that has occurred as a result of the at least one from among the merger and the acquisition.

According to yet another exemplary embodiment, a non-transitory computer readable storage medium storing instructions for generating an insight from public data for potential commercial exploitation is provided. The storage medium includes executable code which, when executed by a processor, causes the processor to: receive a first document that includes first information that has been submitted for compliance with at least one governmental regulation and is publicly available; extract, from the first document, the first information; analyze the extracted first information by applying a first artificial intelligence (AI) algorithm that implements a machine learning technique; and generate at least one insight based on a result of the analysis.

### BRIEF DESCRIPTION OF THE DRAWINGS

The present disclosure is further described in the detailed description which follows, in reference to the noted plurality of drawings, by way of non-limiting examples of preferred embodiments of the present disclosure, in which like characters represent like elements throughout the several views of the drawings.

FIG. 1 illustrates an exemplary computer system.

FIG. 2 illustrates an exemplary diagram of a network environment.

FIG. 3 shows an exemplary system for implementing a method for using artificial intelligence techniques to generate insights from public data for potential commercial exploitation in a speedy, large-scale, and sophisticated manner.

FIG. 4 is a flowchart of an exemplary process for implementing a method for using artificial intelligence techniques to generate insights from public data for potential commercial exploitation in a speedy, large-scale, and sophisticated manner.

FIG. 5 is a chart that illustrates examples of extraction fields and associated insights that may be generated from a Form ADV by a system that implements a method for using artificial intelligence techniques to generate insights from public data for potential commercial exploitation in a speedy, large-scale, and sophisticated manner, according to an exemplary embodiment.

FIG. 6 is a chart that illustrates examples of insights that may be generated from Forms ADV and N-CSR by a system that implements a method for using artificial intelligence techniques to generate insights from public data for potential commercial exploitation in a speedy, large-scale, and sophisticated manner, according to an exemplary embodiment.

FIG. 7 is a chart that illustrates examples of insights that may be generated from Forms NPORT-P, 13F-HR, and D by a system that implements a method for using artificial intelligence techniques to generate insights from public data for potential commercial exploitation in a speedy, large-scale, and sophisticated manner, according to an exemplary embodiment.

FIG. 8 is a screenshot that illustrates a recognition of a tabular alignment of extracted information that is executed by a system that implements a method for using artificial intelligence techniques to generate insights from public data for potential commercial exploitation in a speedy, large-scale, and sophisticated manner, according to an exemplary embodiment.

FIG. 9 is an illustration of a result of extraction and analysis operations that are performed by a system that implements a method for using artificial intelligence techniques to generate insights from public data for potential commercial exploitation in a speedy, large-scale, and sophisticated manner, according to an exemplary embodiment.

### DETAILED DESCRIPTION

Through one or more of its various aspects, embodiments and/or specific features or sub-components of the present disclosure, are intended to bring out one or more of the advantages as specifically described above and noted below.

The examples may also be embodied as one or more non-transitory computer readable media having instructions stored thereon for one or more aspects of the present technology as described and illustrated by way of the examples herein. The instructions in some examples include executable code that, when executed by one or more processors, cause the processors to carry out steps necessary to implement the methods of the examples of this technology that are described and illustrated herein.

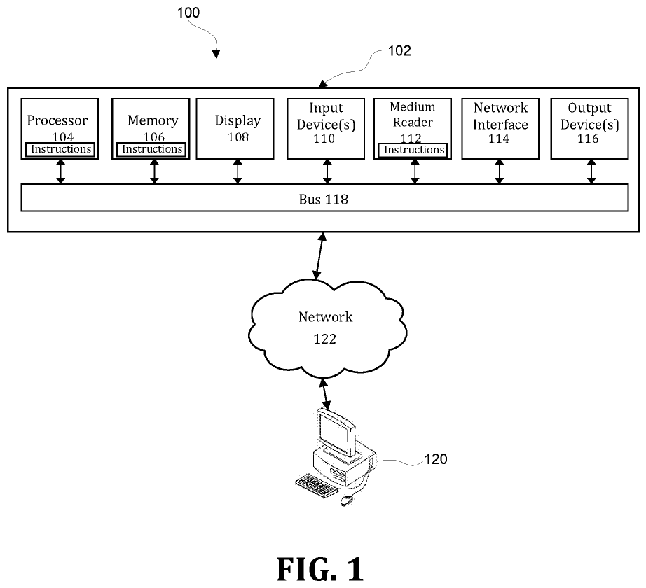

FIG. 1 is an exemplary system for use in accordance with the embodiments described herein. The system 100 is generally shown and may include a computer system 102, which is generally indicated.

The computer system 102 may include a set of instructions that can be executed to cause the computer system 102 to perform any one or more of the methods or computer-based functions disclosed herein, either alone or in combination with the other described devices. The computer system 102 may operate as a standalone device or may be connected to other systems or peripheral devices. For example, the computer system 102 may include, or be included within, any one or more computers, servers, systems, communication networks or cloud environment. Even further, the instructions may be operative in such cloud-based computing environment.

In a networked deployment, the computer system 102 may operate in the capacity of a server or as a client user computer in a server-client user network environment, a client user computer in a cloud computing environment, or as a peer computer system in a peer-to-peer (or distributed) network environment. The computer system 102, or portions thereof, may be implemented as, or incorporated into, various devices, such as a personal computer, a tablet computer, a set-top box, a personal digital assistant, a mobile device, a palmtop computer, a laptop computer, a desktop computer, a communications device, a wireless smart phone, a personal trusted device, a wearable device, a global positioning satellite (GPS) device, a web appliance, or any other machine capable of executing a set of instructions (sequential or otherwise) that specify actions to be taken by that machine. Further, while a single computer system 102 is illustrated, additional embodiments may include any collection of systems or sub-systems that individually or jointly execute instructions or perform functions. The term “system” shall be taken throughout the present disclosure to include any collection of systems or sub-systems that individually or jointly execute a set, or multiple sets, of instructions to perform one or more computer functions.

As illustrated in FIG. 1, the computer system 102 may include at least one processor 104. The processor 104 is tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The processor 104 is an article of manufacture and/or a machine component. The processor 104 is configured to execute software instructions in order to perform functions as described in the various embodiments herein. The processor 104 may be a general-purpose processor or may be part of an application specific integrated circuit (ASIC). The processor 104 may also be a microprocessor, a microcomputer, a processor chip, a controller, a microcontroller, a digital signal processor (DSP), a state machine, or a programmable logic device. The processor 104 may also be a logical circuit, including a programmable gate array (PGA) such as a field programmable gate array (FPGA), or another type of circuit that includes discrete gate and/or transistor logic. The processor 104 may be a central processing unit (CPU), a graphics processing unit (GPU), or both. Additionally, any processor described herein may include multiple processors, parallel processors, or both. Multiple processors may be included in, or coupled to, a single device or multiple devices.

The computer system 102 may also include a computer memory 106. The computer memory 106 may include a static memory, a dynamic memory, or both in communication. Memories described herein are tangible storage mediums that can store data as well as executable instructions and are non-transitory during the time instructions are stored therein. Again, as used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The memories are an article of manufacture and/or machine component. Memories described herein are computer-readable mediums from which data and executable instructions can be read by a computer. Memories as described herein may be random access memory (RAM), read only memory (ROM), flash memory, electrically programmable read only memory (EPROM), electrically erasable programmable read-only memory (EEPROM), registers, a hard disk, a cache, a removable disk, tape, compact disk read only memory (CD-ROM), digital versatile disk (DVD), floppy disk, blu-ray disk, or any other form of storage medium known in the art. Memories may be volatile or non-volatile, secure and/or encrypted, unsecure and/or unencrypted. Of course, the computer memory 106 may comprise any combination of memories or a single storage.

The computer system 102 may further include a display 108, such as a liquid crystal display (LCD), an organic light emitting diode (OLED), a flat panel display, a solid state display, a cathode ray tube (CRT), a plasma display, or any other type of display, examples of which are well known to skilled persons.

The computer system 102 may also include at least one input device 110, such as a keyboard, a touch-sensitive input screen or pad, a speech input, a mouse, a remote control device having a wireless keypad, a microphone coupled to a speech recognition engine, a camera such as a video camera or still camera, a cursor control device, a global positioning system (GPS) device, an altimeter, a gyroscope, an accelerometer, a proximity sensor, or any combination thereof. Those skilled in the art appreciate that various embodiments of the computer system 102 may include multiple input devices 110. Moreover, those skilled in the art further appreciate that the above-listed, exemplary input devices 110 are not meant to be exhaustive and that the computer system 102 may include any additional, or alternative, input devices 110.

The computer system 102 may also include a medium reader 112 which is configured to read any one or more sets of instructions, e.g. software, from any of the memories described herein. The instructions, when executed by a processor, can be used to perform one or more of the methods and processes as described herein. In a particular embodiment, the instructions may reside completely, or at least partially, within the memory 106, the medium reader 112, and/or the processor 110 during execution by the computer system 102.

Furthermore, the computer system 102 may include any additional devices, components, parts, peripherals, hardware, software or any combination thereof which are commonly known and understood as being included with or within a computer system, such as, but not limited to, a network interface 114 and an output device 116. The output device 116 may be, but is not limited to, a speaker, an audio out, a video out, a remote-control output, a printer, or any combination thereof.

Each of the components of the computer system 102 may be interconnected and communicate via a bus 118 or other communication link. As illustrated in FIG. 1, the components may each be interconnected and communicate via an internal bus. However, those skilled in the art appreciate that any of the components may also be connected via an expansion bus. Moreover, the bus 118 may enable communication via any standard or other specification commonly known and understood such as, but not limited to, peripheral component interconnect, peripheral component interconnect express, parallel advanced technology attachment, serial advanced technology attachment, etc.

The computer system 102 may be in communication with one or more additional computer devices 120 via a network 122. The network 122 may be, but is not limited to, a local area network, a wide area network, the Internet, a telephony network, a short-range network, or any other network commonly known and understood in the art. The short-range network may include, for example, Bluetooth, Zigbee, infrared, near field communication, ultraband, or any combination thereof. Those skilled in the art appreciate that additional networks 122 which are known and understood may additionally or alternatively be used and that the exemplary networks 122 are not limiting or exhaustive. Also, while the network 122 is illustrated in FIG. 1 as a wireless network, those skilled in the art appreciate that the network 122 may also be a wired network.

The additional computer device 120 is illustrated in FIG. 1 as a personal computer. However, those skilled in the art appreciate that, in alternative embodiments of the present application, the computer device 120 may be a laptop computer, a tablet PC, a personal digital assistant, a mobile device, a palmtop computer, a desktop computer, a communications device, a wireless telephone, a personal trusted device, a web appliance, a server, or any other device that is capable of executing a set of instructions, sequential or otherwise, that specify actions to be taken by that device. Of course, those skilled in the art appreciate that the above-listed devices are merely exemplary devices and that the device 120 may be any additional device or apparatus commonly known and understood in the art without departing from the scope of the present application. For example, the computer device 120 may be the same or similar to the computer system 102. Furthermore, those skilled in the art similarly understand that the device may be any combination of devices and apparatuses.

Of course, those skilled in the art appreciate that the above-listed components of the computer system 102 are merely meant to be exemplary and are not intended to be exhaustive and/or inclusive. Furthermore, the examples of the components listed above are also meant to be exemplary and similarly are not meant to be exhaustive and/or inclusive.

In accordance with various embodiments of the present disclosure, the methods described herein may be implemented using a hardware computer system that executes software programs. Further, in an exemplary, non-limited embodiment, implementations can include distributed processing, component/object distributed processing, and parallel processing. Virtual computer system processing can be constructed to implement one or more of the methods or functionalities as described herein, and a processor described herein may be used to support a virtual processing environment.

As described herein, various embodiments provide optimized methods and systems for using artificial intelligence techniques to generate insights from public data for potential commercial exploitation in a speedy, large-scale, and sophisticated manner.

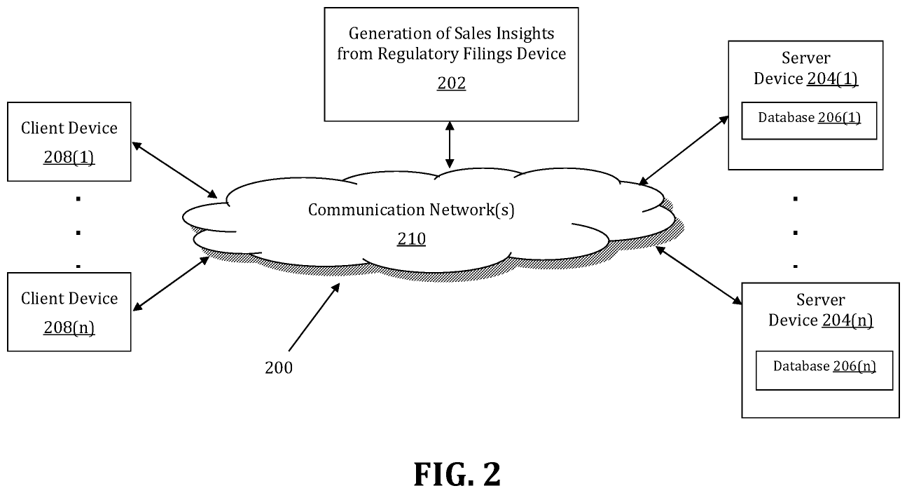

Referring to FIG. 2, a schematic of an exemplary network environment 200 for implementing a method for using artificial intelligence techniques to generate insights from public data for potential commercial exploitation in a speedy, large-scale, and sophisticated manner is illustrated. In an exemplary embodiment, the method is executable on any networked computer platform, such as, for example, a personal computer (PC).

The method for using artificial intelligence techniques to generate insights from public data for potential commercial exploitation in a speedy, large-scale, and sophisticated manner may be implemented by a Generation of Sales Insights from Regulatory Filings (GSIRF) device 202. The GSIRF device 202 may be the same or similar to the computer system 102 as described with respect to FIG. 1. The GSIRF device 202 may store one or more applications that can include executable instructions that, when executed by the GSIRF device 202, cause the GSIRF device 202 to perform actions, such as to transmit, receive, or otherwise process network messages, for example, and to perform other actions described and illustrated below with reference to the figures. The application(s) may be implemented as modules or components of other applications. Further, the application(s) can be implemented as operating system extensions, modules, plugins, or the like.

Even further, the application(s) may be operative in a cloud-based computing environment. The application(s) may be executed within or as virtual machine(s) or virtual server(s) that may be managed in a cloud-based computing environment. Also, the application(s), and even the GSIRF device 202 itself, may be located in virtual server(s) running in a cloud-based computing environment rather than being tied to one or more specific physical network computing devices. Also, the application(s) may be running in one or more virtual machines (VMs) executing on the GSIRF device 202. Additionally, in one or more embodiments of this technology, virtual machine(s) running on the GSIRF device 202 may be managed or supervised by a hypervisor.

In the network environment 200 of FIG. 2, the GSIRF device 202 is coupled to a plurality of server devices 204(1)-204(n) that hosts a plurality of databases 206(1)-206(n), and also to a plurality of client devices 208(1)-208(n) via communication network(s) 210. A communication interface of the GSIRF device 202, such as the network interface 114 of the computer system 102 of FIG. 1, operatively couples and communicates between the GSIRF device 202, the server devices 204(1)-204(n), and/or the client devices 208(1)-208(n), which are all coupled together by the communication network(s) 210, although other types and/or numbers of communication networks or systems with other types and/or numbers of connections and/or configurations to other devices and/or elements may also be used.

The communication network(s) 210 may be the same or similar to the network 122 as described with respect to FIG. 1, although the GSIRF device 202, the server devices 204(1)-204(n), and/or the client devices 208(1)-208(n) may be coupled together via other topologies. Additionally, the network environment 200 may include other network devices such as one or more routers and/or switches, for example, which are well known in the art and thus will not be described herein. This technology provides a number of advantages including methods, non-transitory computer readable media, and GSIRF devices that efficiently implement a method for using artificial intelligence techniques to generate insights from public data for potential commercial exploitation in a speedy, large-scale, and sophisticated manner.

By way of example only, the communication network(s) 210 may include local area network(s) (LAN(s)) or wide area network(s) (WAN(s)), and can use TCP/IP over Ethernet and industry-standard protocols, although other types and/or numbers of protocols and/or communication networks may be used. The communication network(s) 210 in this example may employ any suitable interface mechanisms and network communication technologies including, for example, teletraffic in any suitable form (e.g., voice, modem, and the like), Public Switched Telephone Network (PSTNs), Ethernet-based Packet Data Networks (PDNs), combinations thereof, and the like.

The GSIRF device 202 may be a standalone device or integrated with one or more other devices or apparatuses, such as one or more of the server devices 204(1)-204(n), for example. In one particular example, the GSIRF device 202 may include or be hosted by one of the server devices 204(1)-204(n), and other arrangements are also possible. Moreover, one or more of the devices of the GSIRF device 202 may be in a same or a different communication network including one or more public, private, or cloud networks, for example.

The plurality of server devices 204(1)-204(n) may be the same or similar to the computer system 102 or the computer device 120 as described with respect to FIG. 1, including any features or combination of features described with respect thereto. For example, any of the server devices 204(1)-204(n) may include, among other features, one or more processors, a memory, and a communication interface, which are coupled together by a bus or other communication link, although other numbers and/or types of network devices may be used. The server devices 204(1)-204(n) in this example may process requests received from the GSIRF device 202 via the communication network(s) 210 according to the HTTP-based and/or JavaScript Object Notation (JSON) protocol, for example, although other protocols may also be used.

The server devices 204(1)-204(n) may be hardware or software or may represent a system with multiple servers in a pool, which may include internal or external networks. The server devices 204(1)-204(n) hosts the databases 206(1)-206(n) that are configured to store information that is included in regulatory filings and data that relates to forms that are used for providing required information for compliance with governmental regulations.

Although the server devices 204(1)-204(n) are illustrated as single devices, one or more actions of each of the server devices 204(1)-204(n) may be distributed across one or more distinct network computing devices that together comprise one or more of the server devices 204(1)-204(n). Moreover, the server devices 204(1)-204(n) are not limited to a particular configuration. Thus, the server devices 204(1)-204(n) may contain a plurality of network computing devices that operate using a master/slave approach, whereby one of the network computing devices of the server devices 204(1)-204(n) operates to manage and/or otherwise coordinate operations of the other network computing devices.

The server devices 204(1)-204(n) may operate as a plurality of network computing devices within a cluster architecture, a peer-to peer architecture, virtual machines, or within a cloud architecture, for example. Thus, the technology disclosed herein is not to be construed as being limited to a single environment and other configurations and architectures are also envisaged.

The plurality of client devices 208(1)-208(n) may also be the same or similar to the computer system 102 or the computer device 120 as described with respect to FIG. 1, including any features or combination of features described with respect thereto. For example, the client devices 208(1)-208(n) in this example may include any type of computing device that can interact with the GSIRF device 202 via communication network(s) 210. Accordingly, the client devices 208(1)-208(n) may be mobile computing devices, desktop computing devices, laptop computing devices, tablet computing devices, virtual machines (including cloud-based computers), or the like, that host chat, e-mail, or voice-to-text applications, for example. In an exemplary embodiment, at least one client device 208 is a wireless mobile communication device, i.e., a smart phone.

The client devices 208(1)-208(n) may run interface applications, such as standard web browsers or standalone client applications, which may provide an interface to communicate with the GSIRF device 202 via the communication network(s) 210 in order to communicate user requests and information. The client devices 208(1)-208(n) may further include, among other features, a display device, such as a display screen or touchscreen, and/or an input device, such as a keyboard, for example.

Although the exemplary network environment 200 with the GSIRF device 202, the server devices 204(1)-204(n), the client devices 208(1)-208(n), and the communication network(s) 210 are described and illustrated herein, other types and/or numbers of systems, devices, components, and/or elements in other topologies may be used. It is to be understood that the systems of the examples described herein are for exemplary purposes, as many variations of the specific hardware and software used to implement the examples are possible, as will be appreciated by those skilled in the relevant art(s).

One or more of the devices depicted in the network environment 200, such as the GSIRF device 202, the server devices 204(1)-204(n), or the client devices 208(1)-208(n), for example, may be configured to operate as virtual instances on the same physical machine. In other words, one or more of the GSIRF device 202, the server devices 204(1)-204(n), or the client devices 208(1)-208(n) may operate on the same physical device rather than as separate devices communicating through communication network(s) 210. Additionally, there may be more or fewer GSIRF devices 202, server devices 204(1)-204(n), or client devices 208(1)-208(n) than illustrated in FIG. 2.

In addition, two or more computing systems or devices may be substituted for any one of the systems or devices in any example. Accordingly, principles and advantages of distributed processing, such as redundancy and replication also may be implemented, as desired, to increase the robustness and performance of the devices and systems of the examples. The examples may also be implemented on computer system(s) that extend across any suitable network using any suitable interface mechanisms and traffic technologies, including by way of example only teletraffic in any suitable form (e.g., voice and modem), wireless traffic networks, cellular traffic networks, Packet Data Networks (PDNs), the Internet, intranets, and combinations thereof.

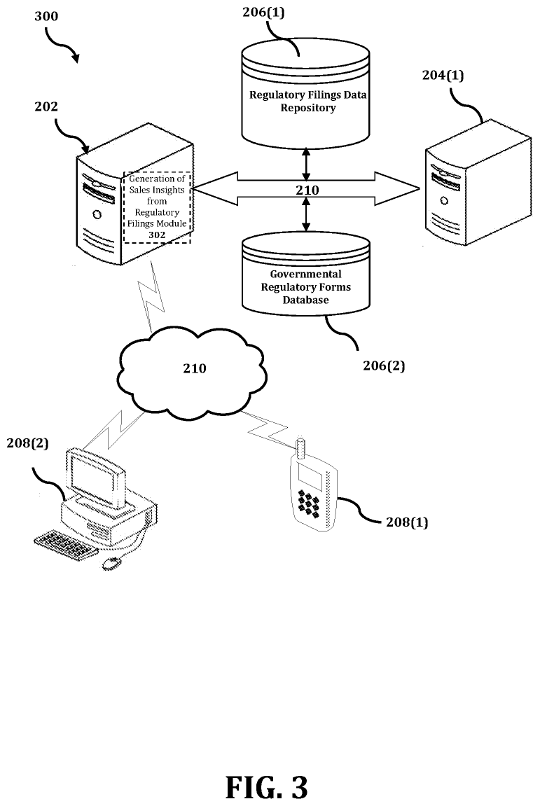

The GSIRF device 202 is described and illustrated in FIG. 3 as including a generation of sales insights from regulatory filings module 302, although it may include other rules, policies, modules, databases, or applications, for example. As will be described below, the generation of sales insights from regulatory filings module 302 is configured to implement a method using artificial intelligence techniques to generate insights from public data for potential commercial exploitation in a speedy, large-scale, and sophisticated manner.

An exemplary process 300 for implementing a mechanism for using artificial intelligence techniques to generate insights from public data for potential commercial exploitation in a speedy, large-scale, and sophisticated manner by utilizing the network environment of FIG. 2 is illustrated as being executed in FIG. 3. Specifically, a first client device 208(1) and a second client device 208(2) are illustrated as being in communication with GSIRF device 202. In this regard, the first client device 208(1) and the second client device 208(2) may be “clients” of the GSIRF device 202 and are described herein as such. Nevertheless, it is to be known and understood that the first client device 208(1) and/or the second client device 208(2) need not necessarily be “clients” of the GSIRF device 202, or any entity described in association therewith herein. Any additional or alternative relationship may exist between either or both of the first client device 208(1) and the second client device 208(2) and the GSIRF device 202, or no relationship may exist.

Further, GSIRF device 202 is illustrated as being able to access a regulatory filings data repository 206(1) and a governmental regulatory forms database 206(2). The generation of sales insights from regulatory filings module 302 may be configured to access these databases for implementing a method for using artificial intelligence techniques to generate insights from public data for potential commercial exploitation in a speedy, large-scale, and sophisticated manner.

The first client device 208(1) may be, for example, a smart phone. Of course, the first client device 208(1) may be any additional device described herein. The second client device 208(2) may be, for example, a personal computer (PC). Of course, the second client device 208(2) may also be any additional device described herein.

The process may be executed via the communication network(s) 210, which may comprise plural networks as described above. For example, in an exemplary embodiment, either or both of the first client device 208(1) and the second client device 208(2) may communicate with the GSIRF device 202 via broadband or cellular communication. Of course, these embodiments are merely exemplary and are not limiting or exhaustive.

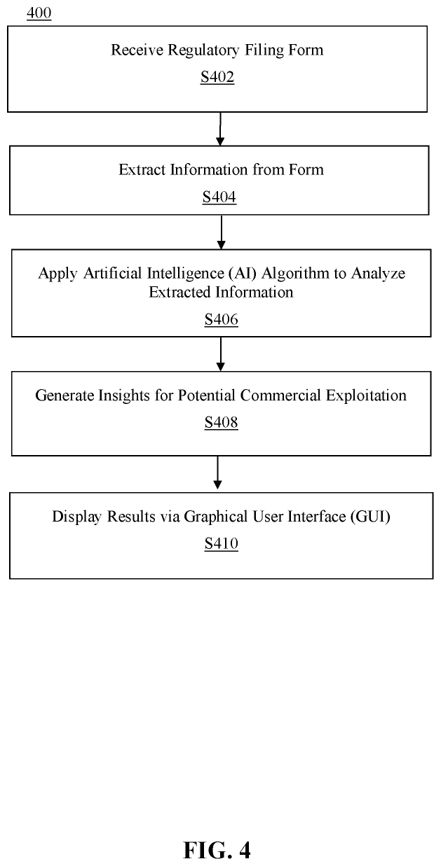

Upon being started, the generation of sales insights from regulatory filings module 302 executes a process for using artificial intelligence techniques to generate insights from public data for potential commercial exploitation in a speedy, large-scale, and sophisticated manner. An exemplary process for using artificial intelligence techniques to generate insights from public data for potential commercial exploitation in a speedy, large-scale, and sophisticated manner is generally indicated at flowchart 400 in FIG. 4.

In process 400 of FIG. 4, at step S402, the generation of sales insights from regulatory filings module 302 receives a document that includes information that has been submitted for compliance with at least one governmental regulation and is publicly available, such as, for example, a regulatory filing form. In an exemplary embodiment, the governmental regulation may be administered by an agency of the United States federal government, such as, for example, the Securities and Exchange Commission (SEC), and the document may be any one or more of a Form ADV, a Form N-CSR, a Form NPORT-P, a Form 13F-HR, a Form N-CEN, a Form N-MFP, and/or a Form D.

At step S404, the generation of sales insights from regulatory filings module 302 extracts the information that has been submitted for regulatory compliance from the document. In an exemplary embodiment, the information includes any one or more of an amount of assets under management (AUM) with respect to a particular asset manager, an amount of assets under custody (AUC) with respect to the particular asset manager, and/or an amount of assets under administration (AUA) with respect to the particular asset manager.

At step S406, the generation of sales insights from regulatory filings module 302 analyzes the extracted information by applying an artificial intelligence (AI) algorithm that implements a machine learning technique with respect to the extracted information. In an exemplary embodiment, the analysis may include identifying, from among the extracted information, information that relates to assets and/or information that relates to liabilities.

In an exemplary embodiment, the analysis may further include identifying at least one tabular structure from within the regulatory filing form and reformatting the information so that it is easily reviewable and digestible by a consumer of the information.

In an exemplary embodiment, the analysis may further include disambiguating information that relates to net assets from information that relates to net assets per investment class.

In an exemplary embodiment, the analysis may further include identifying information that relates to a currency value, and then correlating the currency value with a table header in order to identify a candidate fund name.

At step S408, the generation of sales insights from regulatory filings module 302 generates one or more insights based on a result of the analysis. Then, at step S410, the generation of sales insights from regulatory filings module 302 displays results of the analysis and information that relates to the insight(s) via a graphical user interface (GUI). In an exemplary embodiment, an insight may include an alert that provides a textual message with information that has been gleaned as a result of the analysis, such as, for example, a notification of a changed financial condition that has occurred within a predetermined time interval, such as, for example, within the last day, the last week, the last month, or the last year.

In an exemplary embodiment, a graphical depiction of respective sets of managed assets with respect to a group of subsidiaries may be generated for a particular asset manager that is associated with the subsidiaries. In an exemplary embodiment, an insight may include a message that indicates an effect that has occurred as a result of a merger and/or acquisition that has been completed with respect to a particular asset manager.

In an exemplary embodiment, a method for using artificial intelligence (AI) techniques to generate insights from public data for potential commercial exploitation may be executable by using an autonomously intelligent tool that can source and generate valuable sales insights from thousands of SEC public filings, hereinafter also referred to as an “AI FundSights” tool. In an exemplary embodiment, the AI FundSights operates with speed, scale, and sophistication by leveraging multimodal document AI techniques to solve complex extraction, linking, and aggregation tasks for over 87 million datapoints. The insights automatically generated by the AI FundSights tool complement incumbent client knowledge from subject matter experts with invaluable hard data.

In an exemplary embodiment, the insights that are generated are usable in several ways, including the following: 1) sales lead generation in an alternatives and open-ended fund space; 2) relationship landscape analysis on a granular parent-subsidiary level; 3) advanced wallet share analysis and fee projections; 4) generation of additional target names for mid-tier asset managers; 5) reliable Assets Under Management (AUM) and Assets Under Custody (AUC) calculations; 6) reliable Assets Under Administration (AUA) calculations for fund administration opportunities; 7) comprehensive view of public and private asset space for individual asset managers; 8) growth analysis of AUM, AUC, AUA year over year and automated flags based on relatively large changes; and 9) detailed administrator, fund domicile, gross asset value, and custodian views for each private fund.

In an exemplary embodiment the AI FundSights tool is able to discover and extracted detailed information from Form ADV and Form N-CSR, thus garnering extensive insight into private fund level information, asset manager level information, and public fund level net assets. In addition, the AI FundSights tool operates at a universe-level, capturing all information from all institutions that are required to file with the SEC or disclose such information as per regulations.

In an exemplary embodiment, the insights and data garnered by the AI FundSights tool provide a high degree of transparency into private funds, exchange-traded funds (ETFs), and mutual funds for both institutional and retail investors. The AI FundSights tool also provides access via a plethora of mediums.

In an exemplary embodiment, the AI FundSights tool generates insights from public data at a speed, scale, and sophistication that the use of artificial intelligence (AI) engenders. AI FundSights helps close a gap between information discovery, extraction, and insight generation in a single end-to-end system.

In an exemplary embodiment, the AI FundSights tool ingests and extracts data at the source. For example, the AI FundSights tool can directly download documents from the SEC. Furthermore, the tool is not constrained by any limitations or scale, allowing it to capture the entirety of the universe for many financial advisors. In an exemplary embodiment, the AI FundSights tool operates at a high processing speed, processing over 78 pages/second with a multi-modal AI ingestion pipeline. By sourcing multiple filing forms, the tool can aggregate and link public and private assets into a single platform for end users. Once the data is structured, the AI FundSights tool can generate prompt insights for humans, helping to build cohesion in client/prospect strategies in tandem with incumbent knowledge from subject-matter expertise.

Data Sources: Form ADV—All United States (US)-based financial advisors managing more than $25 million in assets under management (AUM) are required to file Form ADV. These forms are useful in organizing subsidiary breakdowns of asset managers, through private fund administration, discretionary AUM, and non-discretionary AUM. Furthermore, each subsidiary has extensive private fund reporting detailing a private fund's gross asset value, type, and respective business partners (auditors, custodians, prime brokers, etc.). Separately managed accounts and their primary custodians are also reported in Form ADV.

Form N-CSR—Annual Reports, officially designated Form N-CSR, are complex and stylistically diverse filings that are required to disclose public fund information including fund-level net assets, i.e., for calculating assets under custody (AUC). In the US, this form is required by all investment management companies subject to the Investment Company Act of 1940. Each company must report net assets, administration fees, and custody fees in separate tables titled Statements of Assets and Liabilities or Statements of Operations. In addition, there is extensive data related to the holdings of a fund, known as the Schedule of Investments. Form ADV.

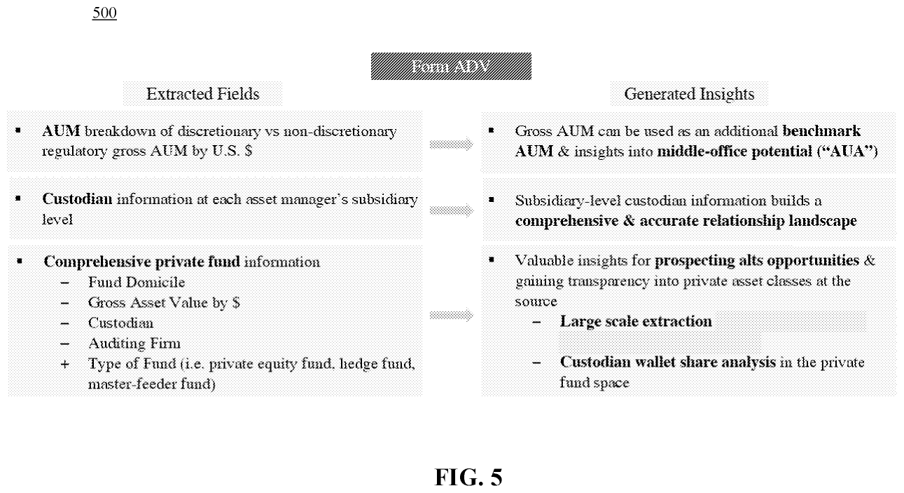

FIG. 5 is a chart 500 that illustrates examples of extraction fields and associated insights that may be generated from a Form ADV by a system that implements a method for using artificial intelligence techniques to generate insights from public data for potential commercial exploitation in a speedy, large-scale, and sophisticated manner, according to an exemplary embodiment. As illustrated in the chart 500, the AI FundSights tool may extract a field that indicates as follows: “AUM breakdown of discretionary versus non-discretionary regulatory gross AUM by U.S. dollars,” and may correspondingly generate an insight as follows: “Gross AUM can be used as an additional benchmark AUM and insights into middle-office potential (“AUA”).” Further, the AI FundSights tool may extract a field that indicates as follows: “Custodian information at each asset manager's subsidiary level,” and may correspondingly generate an insight as follows: “Subsidiary-level custodian information builds a comprehensive and accurate relationship landscape.” Still further, the AI FundSights tool may extract a field that indicates as follows: “Comprehensive private fund information—Fund Domicile; Gross Asset Value by US Dollars; Custodian; Auditing Firm; Type of Fund (i.e., private equity fund, hedge fund, master-feeder fund,” and may correspondingly generate an insight as follows: “Valuable insights for prospecting alts opportunities and gaining transparency into private asset classes at the source—Large Scale Extraction; Custodian wallet share analysis in the private fund space.”

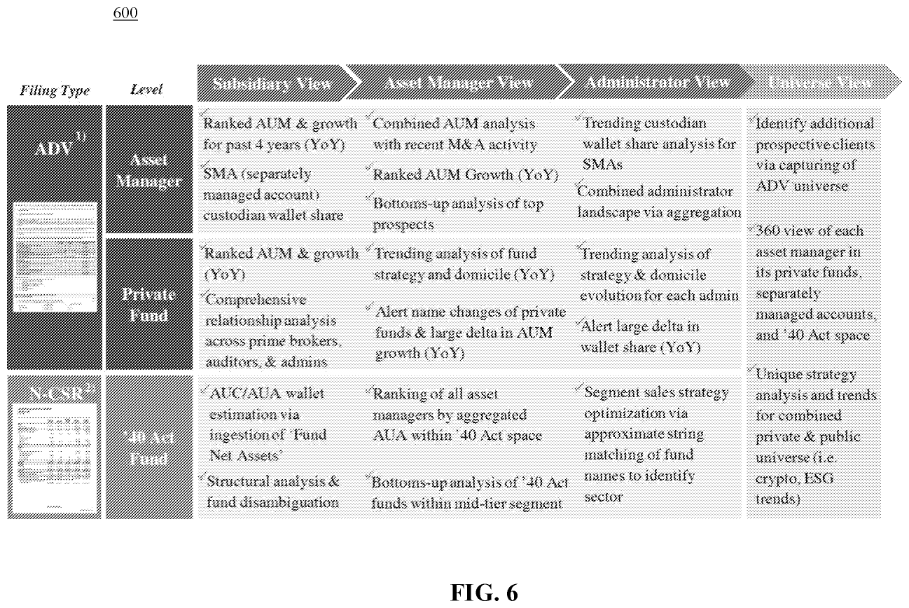

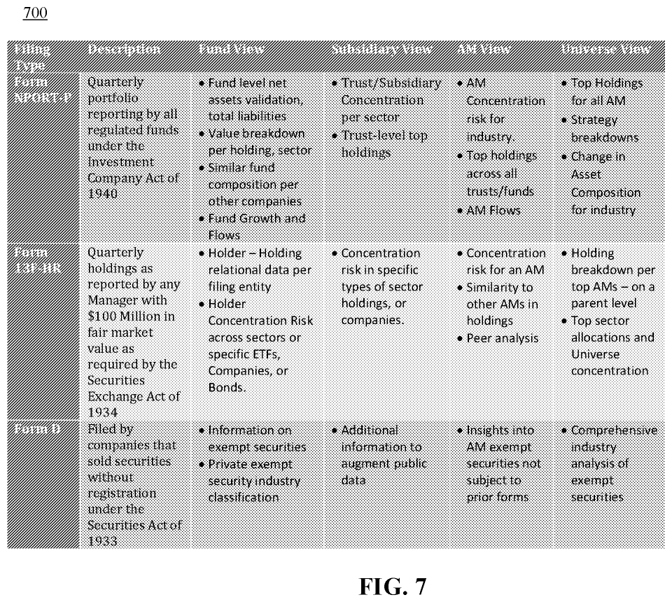

In an exemplary embodiment, the AI FundSights tools consolidates over 87 million data points extracted from the Form ADV and Form N-CSR files, thereby integrating public and private fund information into a single platform. FIG. 6 is a chart 600 that illustrates examples of insights that may be generated from Forms ADV and N-CSR by a system that implements a method for using artificial intelligence techniques to generate insights from public data for potential commercial exploitation in a speedy, large-scale, and sophisticated manner, according to an exemplary embodiment. FIG. 7 is a chart 700 that illustrates examples of insights that may be generated from Forms NPORT-P, 13F-HR, and D by a system that implements a method for using artificial intelligence techniques to generate insights from public data for potential commercial exploitation in a speedy, large-scale, and sophisticated manner, according to an exemplary embodiment.

In an exemplary embodiment, the AI FundSights tool reads and interprets files agnostic to the length, format, and stylistic variability inherent in all filings. In addition, the tool utilizes parsers to ingest PDF documents at a throughput of 78 pages/second. For 700,000 pages comprising 15K ADVs, this takes approximately 2 hours to process. The AI FundSights tool leverages algorithms that represent a fusion of natural language processing and computer vision techniques to extract information with high fidelity. This multi-modal fusion of content allows for accurate form understanding and tabular identification in forms.

In an exemplary embodiment, the AI FundSights tool provides the following capabilities: 1) Automated discovery, download, and ingestion of Form ADV and Form N-CSR from the SEC website; 2) high-speed processing of PDF documents; 3) automated extraction of over 2.4 million data points from Form ADVs and Form N-CSRs; 4) linking and comparison of filings across multiple years to generate insights on major changes; 5) ability to understand documents in different formats and lengths; 6) extraction of data from tables in PDF documents, through a multi-modal fusion of natural language processing and computer vision; 7) automated validation and cross-checking of related data extracted from different sections within a single document, such as, for example, a Statement of Assets and Liabilities versus a Schedule of Investments; 8) ability to match and disambiguate extracted fund names with SEC fund identifiers; 9) inferring fund strategy from fund names, with geography, asset class, and sector trends; and 10) self-resolving subsidiary-to-parent mappings in order to automatically group filings into a single entity.

Form ADVs are standardized in appearance but variable in length. Large firms may file Form ADVs that are disproportionally lengthy, as compared to their smaller peers. The largest ADV is 6,500 pages, and the smallest are only 19-25 pages. This discrepancy in length stems from variability in the number of private funds reported in Section 7.B.1. In an exemplary embodiment, the AI FundSights tool exploits an intelligently bounded search algorithm to section a form into its subcomponents. Next, the AI FundSights tool discovers question prompts and exploits spatial positioning to extract the appropriate value, whether that value is next to the prompt or below the prompt.

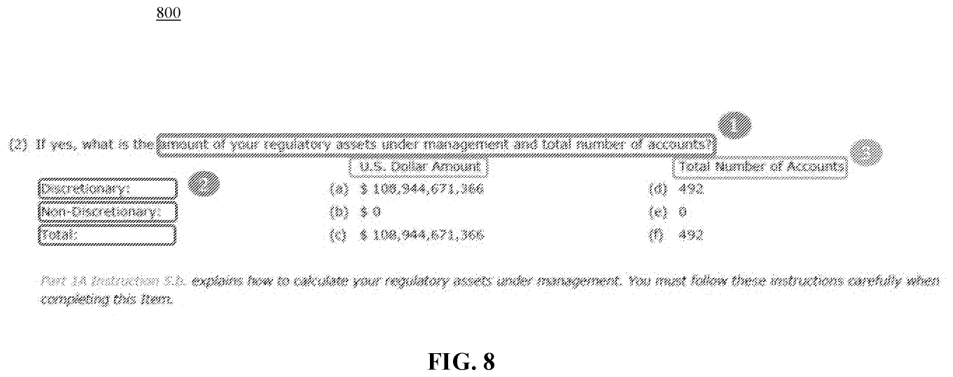

In an exemplary embodiment, the AI FundSights tool also provides context to extracted numbers by its spatial alignment in pseudo-tables. FIG. 8 is a screenshot 800 that illustrates a recognition of a tabular alignment of extracted information that is executed by a system that implements a method for using artificial intelligence techniques to generate insights from public data for potential commercial exploitation in a speedy, large-scale, and sophisticated manner, according to an exemplary embodiment. Referring to FIG. 6, the screenshot 600 displays how first, the AI FundSights tool intelligently searches for a subsidiary's regulatory AUM field (i.e., item 1). However, the response to this field is in a tabular format. The AI FundSights tool can efficiently organize this table such that the tool recognizes the row fields (i.e., item 2) and the column fields (i.e., Item 3). By exploiting the intersection of these values, the AI FundSights too provides context to extracted fields, such as $108,944,672,366 as the Discretionary AUM as opposed to 492 Discretionary Accounts. This additional context from spatially aligned neighbors allows the AI Fundsights tool to disambiguate extracted fields for downstream analysis and aggregation.

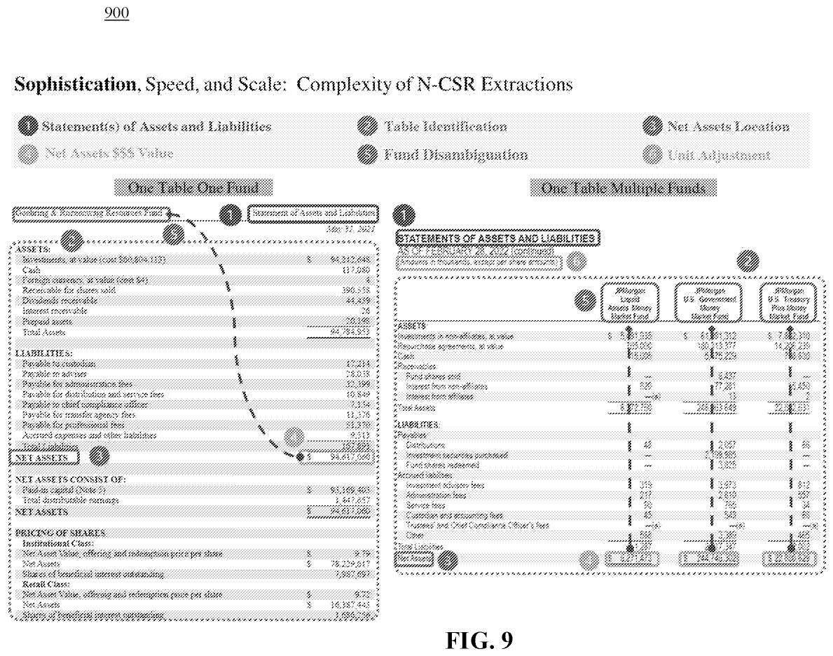

FIG. 9 is an illustration 900 of a result of extraction and analysis operations that are performed by a system that implements a method for using artificial intelligence techniques to generate insights from public data for potential commercial exploitation in a speedy, large-scale, and sophisticated manner, according to an exemplary embodiment.

Annual Reports may be as varied as the number of unique filers. Each document, unlike Form ADV, may be structured and formatted differently. Styles, table layouts, and section headers are all at the purview of the filer. However, the AI FundSights tool can bifurcate these tables into two main categories: Single Fund and Multi-Fund. These two distinct categories are displayed in FIG. 9. Single Fund Tables only report net assets for a single fund, whose name may or may not be in the header, or near the page. The Multi-Fund Table is relatively information dense, with a single table being able to report on several funds. These two styles of tables can both appear in a single N-CSR, and are not guaranteed to be consecutive. In an exemplary embodiment, the AI FundSights tool leverages parsing tools to handle any arbitrary layout of these tables that can be replicated multiple times in a single document.

Furthermore, the AI FundSights tool can extract a net asset value of a particular fund from the Statement of Assets and Liabilities in six steps. FIG. 9 outlines the visual flow of the advanced parsing algorithm to discover, extract, and disambiguate net assets from the Statements of Assets and Liabilities. First, the AI FundSights tool sections the document by pages and uses intelligent search methods to discover the Statements of Assets and Liabilities, the section that concisely reports all net assets of a particular fund that are covered by a unique N-CSR form. It is already known what funds, and their associated SEC Series ID, from the SEC metadata header that can be extracted quickly and accurately. Second, the AI FundSights tool can discover and interpret complex tabular structures within the document, organizing rows and columns in a compact and highly usable format. Third, advanced search tools are utilized; these search tools account for the localized context of net-assets, cross-referenced against shifting variations of the table to find the net assets information that is located directly near or under the total liabilities. This disambiguates the net assets from net assets per investment class, or from varying class contracts. Fourth, the AI FundSights tool searches the row for all possible candidates that may be currency values. Fifth, the AI FundSights tool correlates these extracted monetary values with the inferred table header to discover the candidate fund name. This candidate fund name is disambiguated with respect to the official SEC Series Name and ID, thus linking the net assets values to the true SEC fund. If there is only a single fund reported in a table, the headers may not provide the full name of the fund; however, the AI FundSights tool mitigates this issue by expanding the scope of its search to the entire page and discovering the most probable fund name within. Finally, the AI FundSights tool adjusts the extracted values by the units that may be near the table.

In an exemplary embodiment, the AI FundSights tool automatically generates a global perspective on the public and private universe, by enabling an unobstructed and centralized view of all private funds that are reported in Form ADV. This capability enables relationship managers and salespeople to devise a cohesive global strategy for alternative asset penetration. In addition to the global perspective (e.g., Irish—domiciled funds, Lux-domiciled funds), insights can be generated on private fund strategy, such as hedge fund strategy or private equity fund strategy.

In an exemplary embodiment, the AI FundSights tool enables the user to create a ranking system for any asset manager of choice. For example, the AI FundSights tool may enable an automated custodian wallet share ranking for all private funds with a dedicated dollar value. This view can be expanded to the universe in which insights pertaining to a custodian's total wallet share for all U.S. asset managers can be generated. Moreover, a ranking system according to fund domicile can also be automatically generated.

In an exemplary embodiment, the AI FundSights tool generates comprehensive insights on each asset manager's subsidiary's relationship landscape. This can engender a comprehensive sales strategy that can incorporate geographical considerations, such as the dominance of a particular provider in Asia versus Europe versus US.

In an exemplary embodiment, the AI FundSights tool also automatically generates an integrated perspective of the public and private universe for each asset manager. Moreover, the yearly growth of each subsidiary's AUM can be juxtaposed against asset managers of the user's choice for quick comparison and ranking.

In an exemplary embodiment, the AI FundSights tool also generates insights pertaining to essential events that impact the sales/relationship strategy for asset managers, such as a merger or acquisition. For example, a first entity's private fund domicile and strategy breakdown before its acquisition of a second entity may show an overwhelming concentration on securitized assets. This, in tandem with the public space details, can engender essential points of consideration when contemplating a post-merger scenario.

Within this post-merger scenario, the AI FundSights tool automatically aggregates and combines the private and public assets of each entity to generate a comprehensive landscape post-merger. This is essential in determining future provider landscapes, as the providers of the merging entities may be different. In addition to the provider landscape, an aggregated and ranked view of private fund strategies and AUM can also be generated.

Accordingly, with this technology, an optimized process for using artificial intelligence techniques to generate insights from public data for potential commercial exploitation in a speedy, large-scale, and sophisticated manner is provided.

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the present disclosure in its aspects. Although the invention has been described with reference to particular means, materials and embodiments, the invention is not intended to be limited to the particulars disclosed; rather the invention extends to all functionally equivalent structures, methods, and uses such as are within the scope of the appended claims.

For example, while the computer-readable medium may be described as a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

Although the present application describes specific embodiments which may be implemented as computer programs or code segments in computer-readable media, it is to be understood that dedicated hardware implementations, such as application specific integrated circuits, programmable logic arrays and other hardware devices, can be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

Although the present specification describes components and functions that may be implemented in particular embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims, and their equivalents, and shall not be restricted or limited by the foregoing detailed description.

What is claimed is:

1. A method for generating an insight from public data for potential commercial exploitation, the method being implemented by at least one processor, the method comprising:
receiving, by the at least one processor, a first document that includes first information that has been submitted for compliance with at least one governmental regulation and is publicly available;
extracting, by the at least one processor from the first document, the first information;
analyzing, by the at least one processor, the extracted first information by applying a first artificial intelligence (AI) algorithm that implements a machine learning technique; and
generating, by the at least one processor, at least one insight based on a result of the analyzing.

2. The method of claim 1, wherein the analyzing comprises identifying, from among the extracted first information, second information that relates to assets and third information that relates to liabilities.

3. The method of claim 1, wherein the analyzing comprises identifying at least one tabular structure from within the first document and reformatting information from within the at least one tabular structure.

4. The method of claim 1, wherein the analyzing comprises disambiguating information from within the first information that relates to net assets from information from within the first information that relates to net assets per investment class.

5. The method of claim 1, wherein the analyzing comprises identifying, from among the extracted first information, fourth information that relates to at least one currency value.

6. The method of claim 5, wherein the analyzing further comprises correlating the at least one currency value with a table header in order to identify a candidate fund name.

7. The method of claim 1, wherein the generating comprises generating, for a first asset manager that is associated with a plurality of subsidiaries, a graphical depiction of respective sets of managed assets with respect to corresponding subsidiaries from among the plurality of subsidiaries.

8. The method of claim 1, wherein the generating comprises generating, for a second asset manager that is associated with a fund for which at least one from among a merger and an acquisition has been completed, a message that indicates an effect that has occurred as a result of the at least one from among the merger and the acquisition.

9. The method of claim 1, wherein the generating comprises generating an alert message that includes a notification of a changed financial condition that has occurred within a predetermined time interval.

10. The method of claim 1, wherein the first document includes at least one from among a Form ADV, a Form N-CSR, a Form NPORT-P, a Form 13F-HR, a Form N-CEN, a Form N-MFP, and a Form D.

11. The method of claim 1, wherein the first information includes at least one from among an amount of assets under management (AUM) with respect to a first asset manager, an amount of assets under custody (AUC) with respect to the first asset manager, and an amount of assets under administration (AUA) with respect to the first asset manager.

12. A computing apparatus for generating an insight from public data for potential commercial exploitation, the computing apparatus comprising:
a processor;
a memory;
a display; and
a communication interface coupled to each of the processor, the memory, and the display,
wherein the processor is configured to:
receive, via the communication interface, a first document that includes first information that has been submitted for compliance with at least one governmental regulation and is publicly available;
extract, from the first document, the first information;
analyze the extracted first information by applying a first artificial intelligence (AI) algorithm that implements a machine learning technique; and
generate at least one insight based on a result of the analysis.

13. The computing apparatus of claim 12, wherein the processor is further configured to identify, from among the extracted first information, second information that relates to assets and third information that relates to liabilities.

14. The computing apparatus of claim 12, wherein the processor is further configured to identify at least one tabular structure from within the first document and to reformat information from within the at least one tabular structure.

15. The computing apparatus of claim 12, wherein the processor is further configured to disambiguate information from within the first information that relates to net assets from information from within the first information that relates to net assets per investment class.

16. The computing apparatus of claim 12, wherein the processor is further configured to identify, from among the extracted first information, fourth information that relates to at least one currency value.

17. The computing apparatus of claim 16, wherein the processor is further configured to correlate the at least one currency value with a table header in order to identify a candidate fund name.

18. The computing apparatus of claim 12, wherein the processor is further configured to generate, for a first asset manager that is associated with a plurality of subsidiaries, a graphical depiction of respective sets of managed assets with respect to corresponding subsidiaries from among the plurality of subsidiaries.

19. The computing apparatus of claim 12, wherein the processor is further configured to generate, for a second asset manager that is associated with a fund for which at least one from among a merger and an acquisition has been completed, a message that indicates an effect that has occurred as a result of the at least one from among the merger and the acquisition.

20. A non-transitory computer readable storage medium storing instructions for generating an insight from public data for potential commercial exploitation, the storage medium comprising executable code which, when executed by a processor, causes the processor to:
receive a first document that includes first information that has been submitted for compliance with at least one governmental regulation and is publicly available;
extract, from the first document, the first information;
analyze the extracted first information by applying a first artificial intelligence (AI) algorithm that implements a machine learning technique; and
generate at least one insight based on a result of the analysis.
